(19) United States
(12) Patent Application Publication
(10) Pub. No.: US 2006/0181190 A1
(43) Pub. Date: Aug. 17, 2006

(54) Energy-saving lamp

(76) Inventor: Chao-Lin Wu, Tainan Science Park (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/344,244

(22) Filed: Feb. 1, 2006

(30) Foreign Application Priority Data
Feb. 14, 2005 (TW) 094202490

(51) Int. Cl. H01J 5/48; H01J 5/50

(52) U.S. Cl. 313/318.01

(57) ABSTRACT

An energy-saving lamp includes a base and a bulb mounted on the base. The bulb includes an outer shell and an inner shell mounted inside the outer shell, defining a compartment between the outer shell and the inner shell. Each of the outer shell and the inner shell includes an end. The ends of the inner shell and the outer shell are bonded together. The inner shell includes a chamber wall that defines a chamber inside the inner shell. A tube extends from the chamber wall and through the chamber. The tube includes an inner, open end in communication with the compartment and an outer, closed end outside the inner shell and the outer shell. An energy-saving lamp with an integral design is provided while allowing easy vacuuming pumping operation.

### BACKGROUND OF THE INVENTION

1. Field of the Invention

The present invention relates to a lamp, and more particularly, to an energy-saving lamp.

2. Description of the Related Art

FIG. 1 of the drawings illustrates a conventional energy-saving lamp 1 comprising a base 11 and a bulb 12. A substantially U-shaped lighting tube 13 is mounted in the bulb 12. An interior of the lighting tube 13 is in a vacuum state after pumping air out of the lighting tube 13. The bulb 12 is coupled with the base 11 while providing protection as well as an aesthetic appearance. Heat generated by the lighting tube 13 is dissipated via heat-dissipating holes 111. Namely, the bulb 12 is communicated with the environment and thus not in a vacuum state. Further, the lighting tube 13 is electrically connected to a circuit board (not shown) in the base 11. Hence, the bulb 12 is a separate member in a way and fails to provide an integral design.

### SUMMARY OF THE INVENTION

An objective of the present invention is to provide an energy-saving lamp that presents an integral design.

Another objective of the present invention is to provide an energy-saving lamp that allows easy vacuuming pumping operation.

An energy-saving lamp in accordance with the present invention comprises a base and a bulb mounted on the base. The bulb comprises an outer shell and an inner shell mounted inside the outer shell, defining a compartment between the outer shell and the inner shell. Each of the outer shell and the inner shell comprises an end. The ends of the inner shell and the outer shell are bonded together. The inner shell comprises a chamber wall that defines a chamber inside the inner shell. A tube extends from the chamber wall and through the chamber. The tube comprises an inner, open end in communication with the compartment and an outer, closed end outside the inner shell and the outer shell.

The chamber and the compartment are in a vacuum state.

Preferably, the ends of the inner shell and the outer shell are bonded together by hot melting or gluing.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a conventional energy-saving lamp.

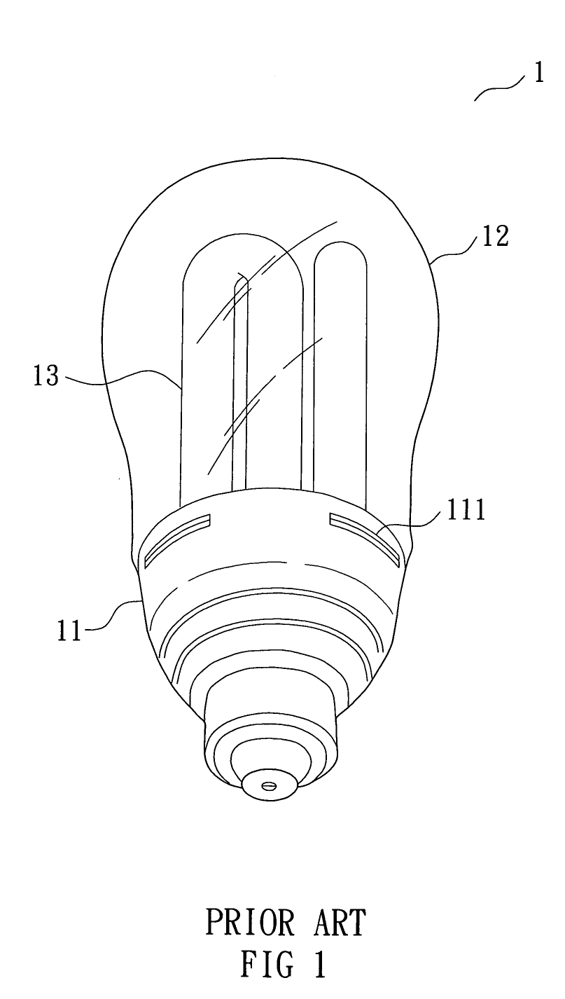

FIG. 2 is a perspective view of an energy-saving lamp in accordance with the present invention.

FIG. 3 is a perspective view of a bulb of the energy-saving lamp in accordance with the present invention.

FIG. 4 is a sectional view of the bulb in FIG. 3.

FIG. 5 is a view similar to FIG. 4, illustrating operation of vacuum pumping.

### DETAILED DESCRIPTION OF THE INVENTION

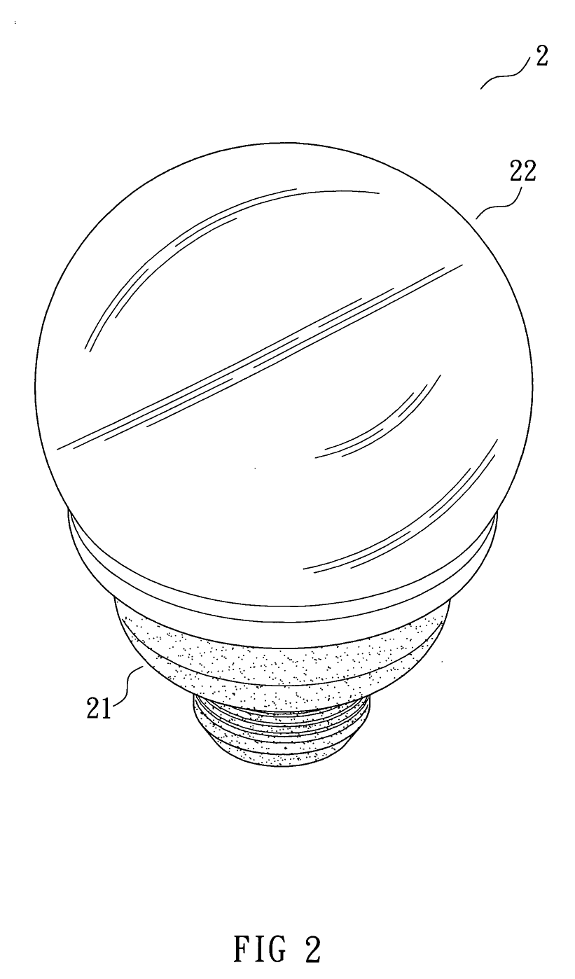

Referring to FIG. 2, an energy-saving lamp 2 in accordance with the present invention comprises a base 21 and a bulb 22 mounted on top of the base 21. The base 21 is substantially a plastic housing and includes electronic elements mounted therein.

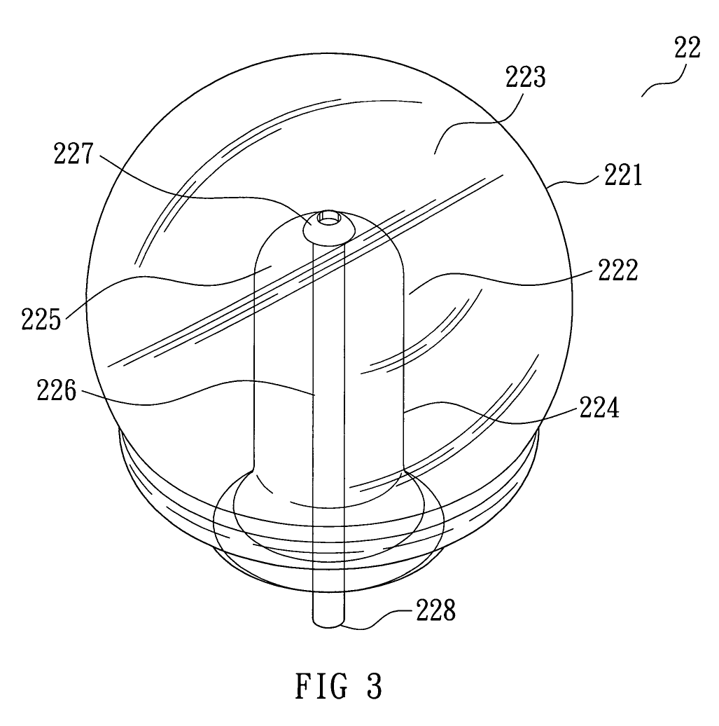

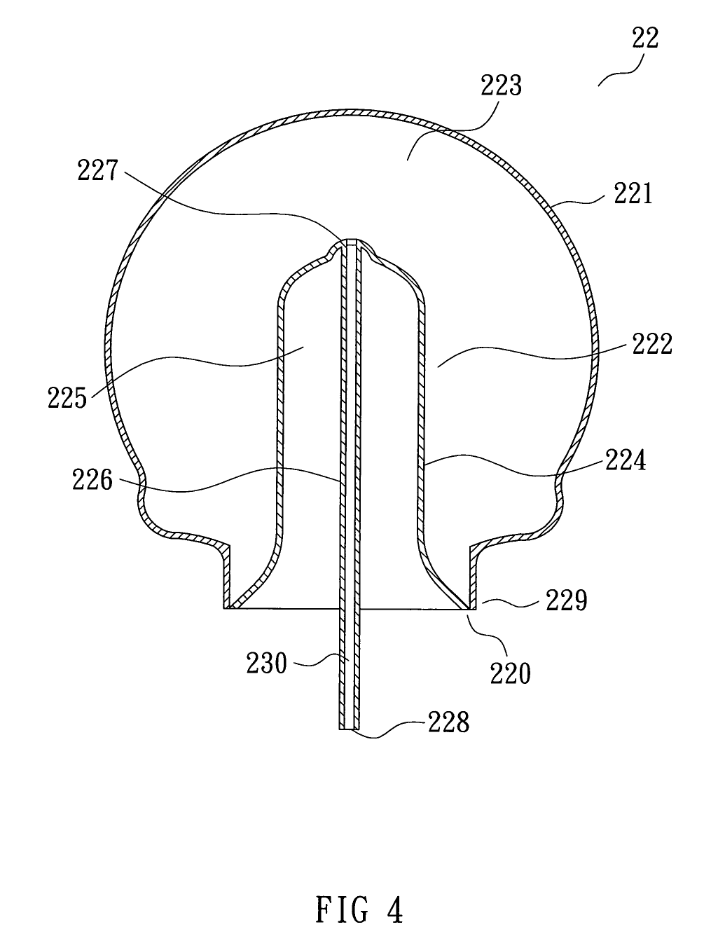

Referring to FIGS. 3 and 4, the bulb 22 comprises an outer shell 221 and an inner shell 222 mounted inside the outer shell 221. A compartment 223 is defined between the outer shell 221 and the inner shell 222. An open end 229 of the inner shell 222 is bonded with an open end 220 of the outer shell 221 by hot melting or gluing, thereby sealing the open ends 229 and 220 of the outer shell 221 and the inner shell 222 and providing a sealed compartment 223.

The inner shell 222 comprises a chamber wall 224, defining a chamber 225 inside the inner shell 222. A tube 226 is mounted in the inner shell 222 and comprises an inner, open end 227 in the chamber wall 224, allowing communication between the compartment 223 and a longitudinal hole 230 of the tube 226. The tube 226 further comprises an outer, closed end 228 extending out of the outer shell 221 and the inner shell 222.

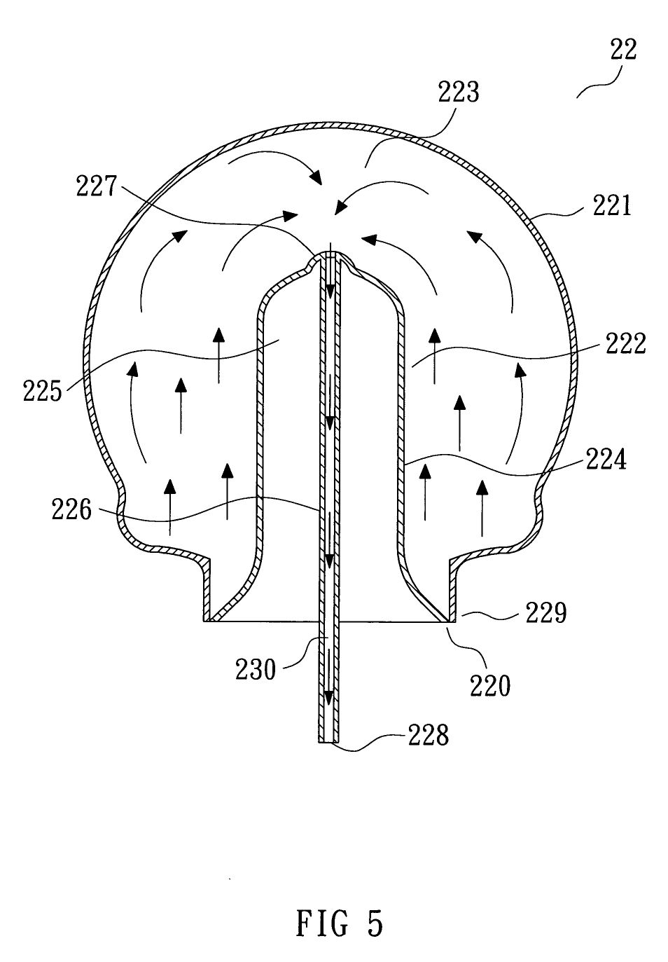

Referring to FIG. 5, the outer end 228 of the tube 226 is open in the beginning, allowing the air in the compartment 223 to be pumped out via the outer end 228 of the tube 226. After the vacuum pumping operation, the compartment 223 between the outer shell 222 and the inner shell 221 is filled with inert gas and a slight amount of mercury vapor, and the outer end 228 of the tube 226 is then sealed.

Conductive mechanism (not shown) is provided in the chamber 225 to provide a gas discharging effect for lighting purposes, which is conventional and therefore not described in detail. The lighting state of the outer shell 222 matches with the electric current state in the chamber 225.

By mounting the inner shell 222 with a chamber 226 inside the outer shell 221 to form a compartment 223 between the inner shell 222 and the outer shell 221 and by bonding the open ends 220 and 229 of the inner shell 222 and the outer shell 221 together, an integral design is provided. Namely, the structural totality of the lamp is improved. Further, the vacuum pumping operation is easy.

Although a specific embodiment has been illustrated and described, numerous modifications and variations are still possible without departing from the essence of the invention. The scope of the invention is limited by the accompanying claims.

1. An energy-saving lamp comprising a base and a bulb mounted on the base, the bulb comprising an outer shell and an inner shell mounted inside the outer shell, defining a compartment between the outer shell and the inner shell, each of the outer shell and the inner shell comprising an end, the ends of the inner shell and the outer shell being bonded together, the inner shell comprising a chamber wall that defines a chamber inside the inner shell, a tube extending from the chamber wall and through the chamber, the tube comprising an inner, open end in communication with the compartment and an outer, closed end outside the inner shell and the outer shell.

2. The energy-saving lamp as claimed in claim 1 wherein the chamber and the compartment are in a vacuum state.

3. The energy-saving lamp as claimed in claim 1 wherein the ends of the inner shell and the outer shell are bonded together by hot melting.

4. The energy-saving lamp as claimed in claim 1 wherein the ends of the inner shell and the outer shell are bonded together by gluing.
